(19) United States
(12) Patent Application Publication
(10) Pub. No.: US 2006/0129701 A1
(43) Pub. Date: Jun. 15, 2006

(54) Communicating an address to a memory device

(76) Inventors: Shekoufeh Qawami, El Dorado Hills, CA (US); Mark P. Leinwander, Folsom, CA (US); Mark N. Fullerton, Austin, TX (US)

Correspondence Address: TROP PRUNER & HU, PC, 8554 KATY FREEWAY, SUITE 100, HOUSTON, TX, 77024, US

(21) Appl. No.: 11/012,316

(22) Filed: Dec. 15, 2004

(51) Int. Cl. G06F 3/00

(52) U.S. Cl. 710/4

(57) ABSTRACT

A technique includes sharing common external terminals of a memory device to communicate data and an address with the memory device for a given memory operation. Different sets of address bits indicative of the address are communicated over the common external terminals at different times.

### BACKGROUND

The invention generally relates to communicating an address to a memory device.

For purposes of reading from or writing to a location in a conventional memory device (a flash memory device, for example), address bits (indicative of the address of the location) may be communicated to the memory device over an address bus. Data bits that are read from the location or written to the location may be communicated to/from the memory device via data bit lines of a separate data bus.

The memory device typically is part of a semiconductor package, and it is quite often desirable to limit the number of external terminals (pads, for example) of the package. Therefore, it is not uncommon for the data and address bits to be communicated with the memory device over the same bit lines of an address/data bus in a time-multiplexed fashion. Thus, due to this arrangement, some of the external terminals of the memory device communicate both address and data bit signals.

A possible limitation of the above-described approach is that for a memory device that has a relatively large memory space, the number of address bits may outnumber the number of data bits. In other words, each memory operation with such a device needs more address bit lines than data bit lines. For example, a typical flash memory device may have between 32 to 512 megabits (Mbits) of storage, thereby requiring an address path of 21 to 25 bits to address the full memory space of the device. The bit width of the data path may be less than the bit width of the address path. As a result, the flash memory device may have a data path that is smaller (in bits) than the address path. To limit the number of external connections to the device, all of the data bit lines may be time-multiplexed with some but not all of the address lines.

Thus, there is a continuing need for better ways to minimize the number of external terminals of a memory device used for purposes of communicating address and data with the device.

### BRIEF DESCRIPTION OF THE DRAWING

FIG. 1 is a block diagram of a memory device according to an embodiment of the invention.

FIG. 2 is a flow diagram depicting a technique to communicate an address to a memory device according to an embodiment of the invention.

FIGS. 3, 4, 5, 6, 7, 8 and 9 are waveforms of signals used to communicate an address to a memory device according to an embodiment of the invention.

FIG. 10 is a block diagram of a microprocessor according to an embodiment of the invention.

FIG. 11 is a block diagram of a wireless system according to an embodiment of the invention.

### DETAILED DESCRIPTION

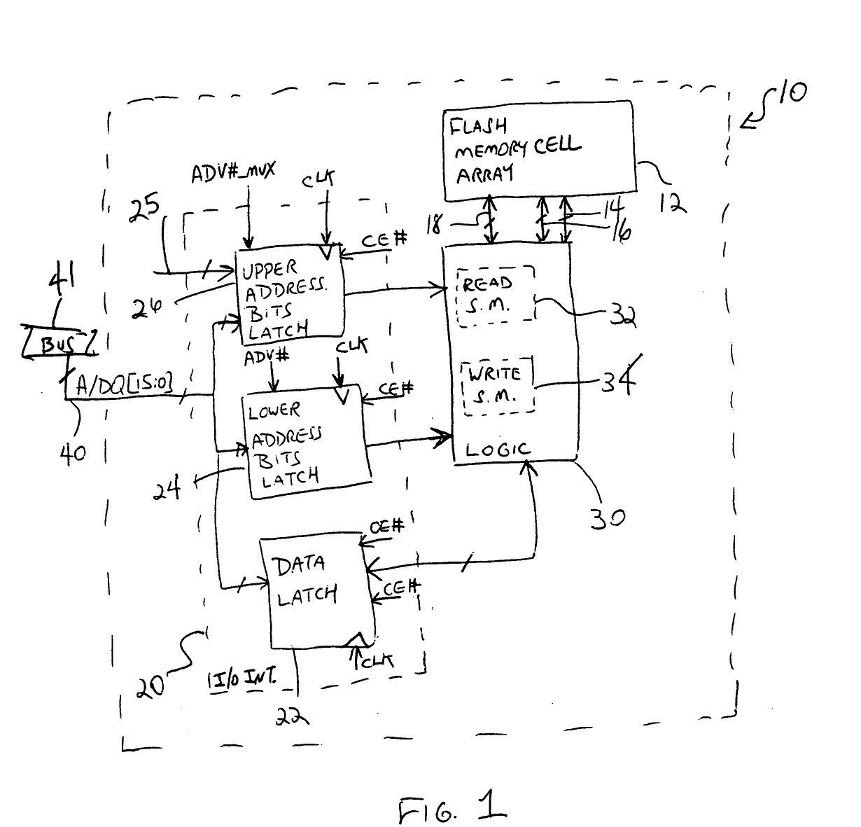

Referring to FIG. 1, an embodiment 10 of a memory device (a flash memory device, for example) in accordance with the invention includes an array 12 of flash memory cells. Data may be stored in the array in a write operation and retrieved from the memory device 10 in a read operation. For purposes of reducing the number of external terminals of the memory device 10, which are used for purposes of communicating address and data bits, the device 10 has external pads (i.e., “terminals”) for communicating address, data and control signals with a bus 41 that is external to the memory device 10. The external pads include pads 40 that are used for communicating address and/or data signals in a time-multiplexed fashion. Thus, in a data phase of a particular read or write operation, the pads 40 communicate bits of data; and in the address phase of the operation, the pads 40 communicate address bits indicating the memory location that is targeted by the operation.

In accordance with some embodiments of the invention, the number of pads 40 (sixteen, for example) may be sufficient to accommodate the size of the incoming/outgoing external datapath of the device 10. However, the number of pads 40 may not be sufficient to communicate all of the address bits for a particular operation.

As a more specific example, in some embodiments of the invention, the address space of the flash memory array 12 may require a relatively large number of address bits, as compared to the size of the data path. For example, a memory space of twenty to twenty-five address bits may address a 32 to 512 megabit (Mbit) address space. Thus, for this memory space size, the memory device 10 may have five to nine additional pads 40 (as an example) beyond the number of pads 40 to communicate the data bits, if not for the features of the present invention. More specifically, in accordance with embodiments of the invention, in systems in which extra address lines are limited, the memory device 10 may be configured in a first mode of operation to use two bus cycles to get all of the address bits on lower address bit lines. As further described below, even with this configuration, the two bus cycle addressing is not needed if the upper address bits have not changed. Multiple time slots are used to communicate address bits with the memory device 40 during a particular operation, a technique that reduces the number of external connections to the device 10 and thus, the number of pads 40 that are used to communicate an address with the device 10.

It is noted that the memory device 10 may also be configured to be in a second mode of operation in which the memory device 10 receives all of the address bits at one time via extended address lines. The above-described first mode of operation is primarily described herein.

More particularly, in accordance with some embodiments of the invention, multiple time slots (herein called “bus cycles” or “bus phases”) are used to communicate data (one phase) and an address (two phases) to the memory device 10 for a particular operation (a read or a write operation, for example). Here, the phrase “bus phase” means an interval of time in which the pads 40 (that are coupled to the bus 41) are exclusively dedicated to communicate either 1.) the upper set of address bits (i.e., the most significant, or higher order, address bits); 2.) the lower set of address bits (i.e., the least significant, or lower order, address bits); and 3.) all of the data bits (in some embodiments of the invention). The upper and lower sets of address bits collectively indicate the address of the targeted memory location.

Thus, to communicate an address, in accordance with some embodiments of the invention, the upper address bits are communicated to the memory device 10 (via the pads 40) over the pads 40 in a first bus phase. When the upper address bits are latched, no decoding is performed at this time. Instead, in accordance with some embodiments of the invention, the memory device 10 holds off, or prevents, decoding until the complete address (upper and lower address bits) is received by the memory device 10. Subsequent to the first bus phase (communicating the upper address bits) in another bus phase, the remaining lower address bits are communicated over the same pads 40. Lastly, the data bits are communicated over the same pads 40 in a subsequent bus phase. Therefore, by sharing the pads 40 in common to communicate the data bits, the upper address bits and the higher order address bits, the number of pads 40 on the memory device 10 is conserved.

Such an arrangement allows more compact boards and/or systems that incorporate the memory device 10. This may reduce both the cost and complexity of these boards and systems.

In some embodiments of the invention, the memory device 10 includes an input/output (I/O) interface 20 that includes a data latch 22 for purposes of capturing data bits from the pads 40 during the data bus phase of the operation. More specifically, in some embodiments of the invention, the pads 40 communicate 16 address/data bit signals (collectively referred to herein as the “A/DQ[15:0] signals”). The data latch 22 synchronizes its operations to a bus clock signal (herein called “CLK”), in some embodiments of the invention. However, in other embodiments of the invention, the operation of the data latch 22 may be asynchronous with respect to the CLK signal.

The data latch 22 also receives a chip enable signal (herein called “CE#”) and an output enable signal (herein called “OE#”). Upon assertion (driving low, for example) of the OE# signal, the data latch 22 either furnishes data signals to the pads 40 or receives data signals from the pad 40 (in synchronization with the CLK signal), depending on whether the associated operation is a read or write operation, respectively. The data latch 22 receives data to be written to the pads 40 from logic 30 of the memory device 10 for a read operation and communicates the data from the pads 40 to the logic 30 for a write operation. The logic 30 includes read 32 and write 34 state machines to control the communication of data with the flash memory cell array 12.

Before data is communicated with (to or from) the flash memory cell array 12, the I/O interface 20 captures the address of the memory location that is targeted by the read/write operation. More specifically, in some embodiments of the invention, the I/O interface 20 includes a lower address bits latch 24 that, as its name implies, captures the least significant address bits that are communicated to the memory device 10 (via the pads 40). For purposes of determining when the least significant address bits are being communicated on the pads 40 (i.e., for purposes of determining when the A/DQ[15:0] signals indicate the least significant address bits), the latch 24 receives a strobe signal (herein called the “ADV# signal”). The ADV# signal is asserted (driven low, for example) when the least significant address bits are present on the pads 40. Thus, in response to the assertion of the ADV# signal, the latch 24 recognizes the lower address bus phase and latches the least significant address bits from the A/DQ[15:0] signals.

In some embodiments of the invention, the most significant address bits are presented on the pads 40 before the lower address bits. More specifically, in accordance with some embodiments of the invention, another strobe signal (herein called the “ADV#_MUX signal”) is asserted (driven low, for example) to indicate the bus phase in which the upper address bit signals appear on the pads 40. Therefore, in response to the assertion of the ADV#_MUX signal, the latch 26 latches the most significant address bits from the A/DQ[15:0] signals. It is noted that the latch 26 may latch the upper address bits wherever a bus cycle is available before a read/write cycle starts. Thus, whenever the ADV#_MUX signal is toggled the address from the bus 41 is latched and kept until the read/write cycle starts. However, the latching of the upper address bits needs to occur before the read state machine 32 starts its cycle (i.e., the order of upper and lower address bits cannot be switched). Otherwise, the previous upper address bits may be erroneously used.

In some embodiments of the invention, the memory device 10 may be configurable to be in the above-mentioned alternative second mode of operation in which the upper address bits are latched through external address lines 25 instead of through the two bus cycle addressing. Thus, the ADV# signal is used in the first and second modes of operation, whereas the ADV#_MUX signal is used only in the first mode of operation. The first mode of operation in which bus phases, or multiple cycles, are used to communicate an address to the memory device 10 is described below.

At the conclusion of the upper address bits and lower address bits bus phases, the latches 24 and 26 store the complete set of address bits for a particular operation. The complete set of address bits are then communicated to the logic 30 so that the logic 30 may decode the address to select the appropriate cells of the flash memory cell array 12. Thus, in some embodiments of the invention, the entire address is decoded only after all (upper and lower) address bits have been received by the memory device 10.

The beginning of read and write cycles with the memory device 10 occurs in response to the same signaling used in conventional flash memory devices (in some embodiments of the invention) to indicate the beginning, such as ADV# signal or CLK signal toggling, or the ADV# signal being held low, read cycles starting, etc. In some embodiments of the invention, this signaling alerts the read state machine 32 or write state machine 34 as to the beginning of the read/write operation. In some embodiments of the invention, the logic 30 communicates with the flash memory cell array 12 via data lines 18, address lines 16 and control signals 14.

As a more specific example, FIG. 2 depicts a technique 50 for communicating an address to the memory device 10. The technique 50 includes determining (diamond 52) whether a change has occurred in the upper address bits. It is noted that the determination (diamond 52) is made by software of a computer system (containing the memory device 10) or a memory controller that is coupled to the bus 41. This determination (diamond 52) is in light of the observation that quite often, successive accesses to the memory device 10 may target the same general memory space, a memory space whose cells are addressed by the same upper address bits. Therefore, the upper address bits may not change between successive memory operations. Thus, it may be determined (diamond 52) that the upper address bits do not need to be communicated for a particular memory operation, as these bits have not changed. However, if the upper address bits have changed, the upper address bits are communicated over the bus 41 (FIG. 1) (and to the memory device 10), as depicted in block 54. Regardless of when the upper address bits change, the memory device 10 latches bits from the bus 41 if the ADV_MUX# signal toggles. Regardless of whether or not the upper address bits are communicated over the bus 41, the lower address bits are then communicated over the bus 41, as depicted in block 58. Subsequently, pursuant to the technique 50, the data bits are communicated over the bus 41, as depicted in block 60.

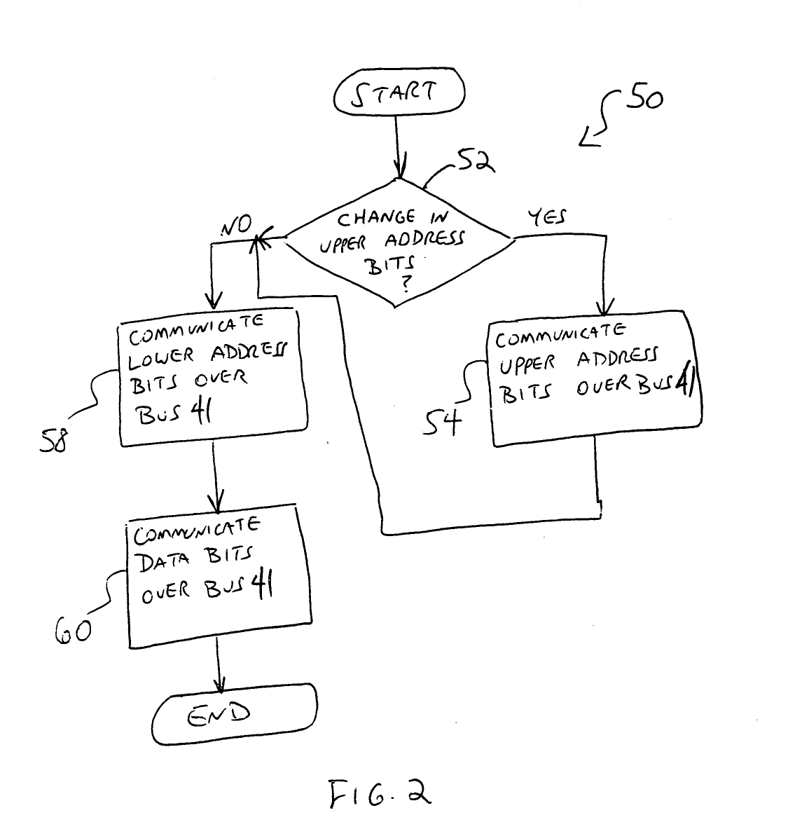

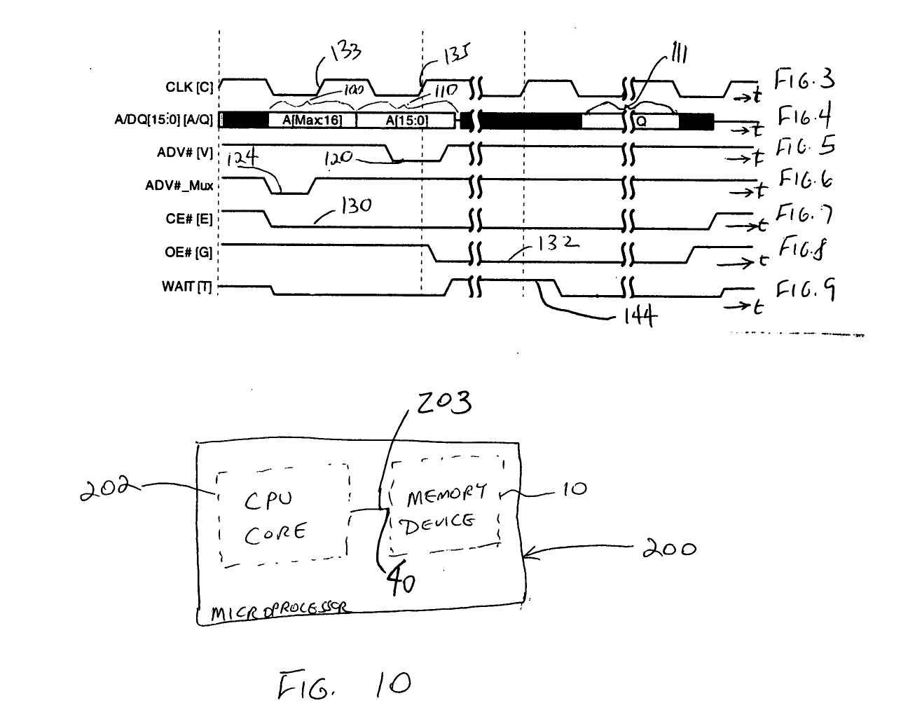

FIGS. 3, 4, 5, 6, 7, 8 and 9 are exemplary waveforms that are communicated over the bus 41 (see also FIG. 1) and received by the memory device 10 in some embodiments of the invention for a particular read/write operation. More specifically, as depicted in FIG. 4, in some embodiments of the invention, the memory read/write operation begins with the ADV# signal being driven low. As shown in FIG. 4, the beginning of the operation may be preceded by a bus phase 100 in which the A/DQ[15:0] signals (FIG. 4) indicate the upper address bits, and the memory device 10 latches the address bits due to the ADV#_MUX signal, as depicted in FIG. 6, during an upper address bus phase 100. Thus, when the ADV#_Mux signal is de-asserted, the memory device 10 recognizes the upper address phase. Therefore, in response to the assertion of the ADV#_Mux signal, the memory device 10 responds (such as at a positive going edge 133 of the CLK signal (FIG. 3) or the positive edge of the ADV#_Mux signal, as examples) to capture the upper address bits from the bus.

The ADV# signal (FIG. 5) is used in a similar manner to communicate the lower address bits across the bus 41. More specifically, in some embodiments of the invention, the device that communicates with the memory device 10, after de-asserting the ADV#_Mux signal, asserts the ADV# signal to indicate that the A/DQ[15:0] signals (FIG. 4) are indicating the lower address bits during a subsequent lower address bit phase 110 (see FIG. 4). Therefore, in response to the assertion of the ADV# signal, the memory device 10 captures the lower address bits from the bus 41 (such as at a positive going edge 135 of the CLK signal (see FIG. 3), for example). Therefore, at the conclusion of the bus phases 100 and 110, the memory device 10 has captured the entire address for the particular operation.

As also depicted in FIG. 4, in some embodiments of the invention, the upper address bit phase 100 and the lower address bit phase 110 both proceed a data phase 111, a phase in which the A/DQ[15:0] signals indicate the data for the particular operation. For a write operation, the memory device 10 receives the data (via the A/DQ[15:0] signals) from the bus 41; and for a read operation, the memory device 10 provides the data (also via the A/DQ[15:0] signals) to the bus.

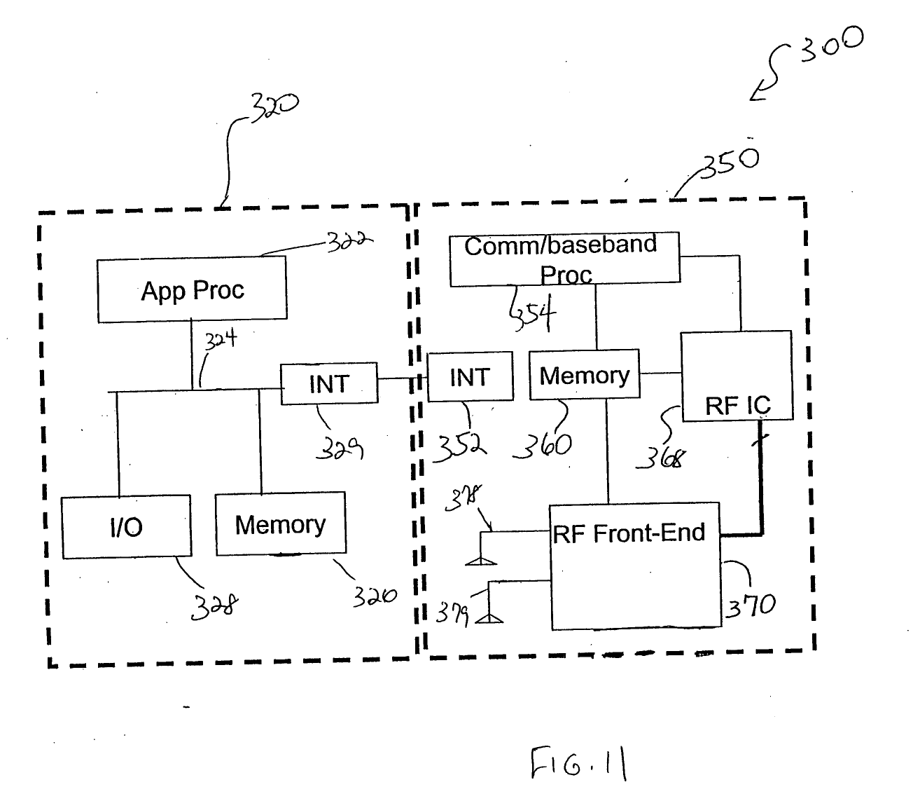

Additional signals are depicted in FIGS. 7, 8 and 9, as these signals may accompany the A/DQ[15:0], CLK, ADV# and ADV#_Mux signals, in some embodiments of the invention. For example, FIG. 7 depicts the CE# signal, a signal that is asserted (as shown at reference numeral 130) to enable the operation with the memory device 10. FIG. 8 depicts the OE# signal, a signal that is asserted (as shown at reference numeral 132) during the data phase of the bus. FIG. 9 depicts a signal called WAIT, a signal that is asserted (as depicted at reference numeral 144) by the memory device 10 to hold off the data bus phase until the memory device 10 is capable of responding.

It is noted that the signals that are depicted in FIGS. 3-9 are merely shown as an example only. Therefore, many other variations are possible in other embodiments of the invention and are in the scope of the appended claims. For example, multiple bus phases may be used to communicate data with the memory device 10.

In some embodiments of the invention, the memory device 10 may be part of a microprocessor, such as a microprocessor 200 that is depicted in FIG. 10. More specifically, in some embodiments of the invention, the microprocessor 10 may include a central processing unit (CPU) core 202 that is coupled to the pads 40 of memory device 10 via a bus 203.

As another example of an application of the memory device 10, in some embodiments of the invention, a device such as the memory device 10 may be used in a wireless communication system 300. More specifically, the memory device 10 may be used as either a memory 360 of a communication subsystem 350 of the wireless device 300 and/or a memory 320 of an application subsystem of the wireless system 300, depending on the particular embodiment of the invention.

In some embodiments of the invention, the communication subsystem 350, as its name implies, forms the communication interface for the wireless device 300 to a wireless network. The communication subsystem 350 includes a radio frequency (RF) front end device 370 that forms an interface for the wireless device 300 to one or more antennas 378 and 379 (dipole antennas, for example). More specifically, in some embodiments of the invention, the RF front end device 370 may include such features as an antenna switch to select between the appropriate antenna 378, 379; low noise amplifiers to receive RF signals from the antennas 378 and 379; bandpass filters; and possibly mixers to demodulate the received RF signals to lower frequency signals before providing the signals to an RF integrated circuit 368. For its transmit path, the RF front end device 370 may use the antenna switch to select the appropriate antenna and may use such other features as power amplifiers to drive the selected antenna 378, 379; bandpass filters; and possibly mixers to modulate the signals that drive the antennas 378 and 379.

The RF front end device 370, in some embodiments of the invention, may communicate RF and/or intermediate frequency (IF) signals with the RF integrated circuit 368. The RF integrated circuit 368, in some embodiments of the invention, performs modulation (for its transmit path) and demodulation (for its receive path) for purposes of communicating baseband signals with a processor 354. However, in other embodiments of the invention, the RF integrated circuit 368 may also contain a baseband processor. Therefore, depending on the particular embodiment of the invention, the processor 354 may be a baseband processor that controls baseband processing, as well as controls operation of the communication subsystem; or a communication processor that controls operation of the communication subsystem 350 without performing any baseband processing. In some embodiments of the invention, the processor 354 may be combined with the RF integrated circuit 368 as a chip set, a single integrated package or a multichip module, as just a few examples.

In some embodiments of the invention, the wireless device 10 may be a cellular telephone or a device (such as a personal digital assistant (PDA), notebook computer, camera, etc.) that has wireless capabilities and possibly other capabilities that are not related to wireless communication. In addition to the communication subsystem 350, the wireless device 300 may also include an application subsystem 320.

The application subsystem 320, as its name implies, executes application programs (an email application, a web surfing application, an address contact list, a speed-dial list, etc.) for the wireless device 300. The application subsystem 320 includes an application processor 322 that executes instructions that are associated with the various applications that are stored in the memory 326. The memory 326 and the application processor 322 communicate, for example, over a system bus 324 that is coupled to an input/output (I/O) interface 329. The I/O interface 329 communicates with a corresponding I/O interface 352 of the communication subsystem 350.

In some embodiments of the invention, the application subsystem 320 may include, for example, an I/O interface 328 that forms an input interface for receiving input data from a keypad or touch screen, may provide audio signals to a speaker of the wireless device 300, may provide an output signal to a headphone that is coupled to the wireless device 300, may provide video signals to drive a display of the wireless device 300, etc.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
sharing common external terminals of a memory device to communicate data and an address with the memory device for a given memory operation; and
communicating different sets of address bits indicative of the address over the common external terminals at different times.

2. The method of claim 1, wherein said different sets of address bits comprise a first set of address bits associated with a higher bit order of the address and a second set of address bits associated with a lower bit order of the address.

3. The method of claim 2, further comprising:
latching the first set of address bits in response to a first bus phase before a time period allocated for latching of the address in connection with the operation; and
subsequently latching the second set of address bits in response to a second bus phase other than the first bus phase.

4. The method of claim 3, further comprising:
triggering the latching of the first set of address bits in response to a first strobe signal; and
triggering the latching of the second set of address bits in response to a second strobe signal other than the first strobe signal.

5. The method of claim 2, further comprising:
selectively latching the first set of address bits; and
latching the second set of address bits.

6. The method of claim 2, further comprising:
communicating the first set of address bits over the external terminals during a first bus phase;
communicating the second set of address bits over the external terminals during a second bus phase; and
communicating the data over the external terminals during a third bus phase, wherein
the first, second and third bus phases do not overlap each other in time.

7. The method of claim 2, further comprising:
selectively communicating the first set of address bits over the external terminals during a first bus phase; and
communicating the second set of address bits over the external terminals during a second bus phase.

8. The method of claim 7, wherein the act of selectively communicating comprises:
determining whether the first set of address bits was communicated to the memory device during a preceding bus phase.

9. The method of claim 1, further comprising:
using different strobe signals for said different times to trigger capture of the address bits.

10. The method of claim 1, wherein said different times comprise different bus phases.

11. The method of claim 1, wherein the memory operation comprises one of a read operation and a write operation.

12. A memory device comprising:
a memory array;
external terminals to communicate data and an address with the memory device for a given memory operation; and
a circuit to receive different sets of address bits indicative of the address over the external terminals at different times and prevent decoding of the address until all of the sets of address bits are received.

13. The memory device of claim 12, wherein said different sets of address bits comprise a first set of address bits associated with a higher bit order of the address and a second set of address bits associated with a lower bit order of the address.

14. The memory device of claim 13, wherein the circuit places the memory device in a first mode in which all bits of the address are received by the memory device during the same bus phase or a second mode in which the memory device receives said different sets of address bits at different times.

15. The memory device of claim 13, wherein the circuit latches the first set of address bits in response to a first strobe signal and latches the second set of address bits in response to a second strobe signal other than the first strobe signal.

16. The memory device of claim 13, wherein the circuit latches the first set of address bits before latching the second set of address bits.

17. The memory device of claim 11, wherein the circuit responds to a different strobe signal in each of said different times to trigger capture of each of said sets of address bits.

18. The memory device of claim 11, wherein the memory array comprises an array of flash memory cells.

19. A system comprising:
a memory comprising external terminals shared in common to communicate data and an address with the memory device for a given memory operation, the memory device to receive different sets of address bits indicative of the address over the external terminals at different times; and
a wireless interface.

20. The system of claim 19, wherein the wireless interface comprises a dipole antenna.

21. The system of claim 19, wherein the memory comprises a flash memory.

22. The system of claim 19, wherein said different sets of address bits comprise a first set of address bits associated with a higher bit order of the address and a second set of address bits associated with a lower bit order of the address.

23. The system of claim 22, wherein the memory latches the first set of address bits in response to a first bus phase before a time period allocated for latching of the address bits in connection with the operation and subsequently latches the second set of address bits in response to a second bus phase other than the first bus phase.

24. A microprocessor, comprising:
a central processing unit core; and
a memory comprising terminals shared in common to communicate data and an address between the core and the memory device for a given memory operation, the memory device to receive different sets of address bits indicative of the address over the terminals at different times.

25. The microprocessor of claim 24, wherein said different sets of address bits comprise a first set of address bits associated with a higher bit order of the address and a second set of address bits associated with a lower bit order of the address.

26. The microprocessor of claim 25, wherein the memory latches the first set of address bits in response to a first bus phase before a time period allocated for latching of the address bits in connection with the operation and subsequently latches the second set of address bits in response to a second bus phase other than the first bus phase.

27. The microprocessor of claim 25, wherein the memory latches the first set of address bits in response to a first strobe signal and latches the second set of address bits in response to a second strobe signal other than the first strobe signal.
